(19) United States
(12) Patent Application Publication
(10) Pub. No.: US 2026/0159354 A1
(43) Pub. Date: Jun. 11, 2026

(54) DETERMINATION OF AN ELEVATOR LANDING ASSOCIATED WITH A USER DEVICE

(71) Applicant: KONE Corporation, Helsinki (FI)

(72) Inventor: Viljami PIRTTIMAA, Helsinki (FI)

(73) Assignee: KONE Corporation, Helsinki (FI)

(21) Appl. No.: 19/463,553

(22) Filed: Jan. 29, 2026

Related U.S. Application Data
(63) Continuation of application No. PCT/EP2023/073393, filed on Aug. 25, 2023.

(51) Int. Cl. B66B 1/34; B66B 1/46; G01C 5/06

(52) U.S. Cl. CPC B66B 1/3461; B66B 1/3492; B66B 1/468; G01C 5/06; B66B 2201/4638; B66B 2201/4653

(57) ABSTRACT

According to an aspect, there is provided a system for determining a current elevator landing associated with a user device. The system comprises at least one processor and at least one memory storing instructions that, when executed by the at least one processor, cause the system to at least perform: maintaining, based on barometric pressure value measurements from at least one barometric pressure sensor device arranged in at least one elevator landing, a barometric pressure model associated with a building comprising a plurality of elevator landings, the barometric pressure model identifying air pressure at each elevator landing of the plurality of elevator landings; obtaining, from the user device, a barometric pressure value associated with the user device; and determining a current elevator landing associated with the user device based at least in part on the barometric pressure value and the barometric pressure model.

### TECHNICAL FIELD

Various examples generally relate to the field of elevator systems. In particular, some examples relate to a solution for determining an elevator landing associated with a user device.

### BACKGROUND

Elevator systems may enable a solution in which a mobile application executed, for example, in a user's mobile device can be used to make elevator calls. When making an elevator call with the mobile application, typically the user needs to input to the mobile application both a source floor (i.e., a current elevator landing) and a destination floor. One possibility for the source floor issue is that a default source floor, for example, a bottom floor of a building, may be used. In this way, the source floor would at least on some occasions be correct and the user does not have to separately input it. This, however, works only sometimes, and the user still needs to input also the source floor in most of the elevator calls made with the mobile application.

When the user needs to manually input also the source floor in the mobile application, it makes the use of the mobile application unintuitive and inefficient. This also makes the user less likely to use the mobile application for calling the elevator because it is easier for the user to use the a destination operating panel (DOP) or a car operating panel (COP) instead.

### SUMMARY

The scope of protection sought for various example embodiments of the disclosure is set out by the independent claims. The example embodiments and features, if any, described in this specification that do not fall under the scope of the independent claims are to be interpreted as examples useful for understanding various example embodiments of the disclosure.

According to a first aspect, there is provided a system for determining a current elevator landing associated with a user device. The system comprises at least one processor, and at least one memory storing instructions that, when executed by the at least one processor, cause the system to at least perform: maintaining, based on barometric pressure value measurements from at least one barometric pressure sensor device arranged in at least one elevator landing, a barometric pressure model associated with a building comprising a plurality of elevator landings, the barometric pressure model identifying an air pressure at each elevator landing of the plurality of elevator landings; obtaining, from the user device, a barometric pressure value associated with the user device; and determining a current elevator landing associated with the user device based at least in part on the barometric pressure value and the barometric pressure model.

In an implementation form of the first aspect, the barometric pressure value associated with the user device comprises a barometric pressure value corrected with a calibration offset value associated with the user device.

In an implementation form of the first aspect, the at least one memory stores instructions that, when executed by the at least one processor, cause the system to at least perform: obtaining a calibration offset value associated with the user device; correcting the barometric pressure value based on the calibration offset value to determine a corrected barometric pressure value; and determining the current elevator landing associated with the user device based at least in part on the corrected barometric pressure value and the barometric pressure model.

In an implementation form of the first aspect, the at least one memory stores instructions that, when executed by the at least one processor, cause the system to at least perform: obtaining the calibration offset value associated with the user device from the user device together with the measured barometric pressure value associated with the user device.

In an implementation form of the first aspect, the at least one memory stores instructions that, when executed by the at least one processor, cause the system to at least perform: storing the calibration offset value associated with the user device in the at least one memory together with an identifier associated with the user device; receiving, from the user device, the identifier associated with the user device; and obtaining the calibration offset value associated with the user device from the at least one memory based on the identifier received from the user device.

In an implementation form of the first aspect, the at least one memory stores instructions that, when executed by the at least one processor, cause the system to at least perform: receiving, from the at least one barometric pressure sensor device arranged in at least one elevator landing, at least one barometric pressure value measurement update; and updating the barometric pressure model based on the at least one barometric pressure value measurement update.

In an implementation form of the first aspect, the at least one memory stores instructions that, when executed by the at least one processor, cause the system to at least perform: transmitting the current elevator landing associated with the user to the user device.

In an implementation form of the first aspect, the at least one memory stores instructions that, when executed by the at least one processor, cause the system to at least perform: determining a confidence level associated with the current elevator landing associated with the user device, the confidence level representing the compatibility of the barometric pressure value associated with the user device to the barometric pressure model; and transmitting the confidence level to the user device.

In an implementation form of the first aspect, the at least one memory stores instructions that, when executed by the at least one processor, cause the system to at least perform: obtaining an identifier associated with the user device; and transmitting the current elevator landing associated with the user device and the identifier associated with the user device to an elevator controller or an elevator group controller.

In an implementation form of the first aspect, the at least one memory stores instructions that, when executed by the at least one processor, cause the system to at least perform: receiving positioning data associated with the user device; and determining a barometric pressure model to be applied based on the positioning data.

In an implementation form of the first aspect, the at least one memory stores instructions that, when executed by the at least one processor, cause the system to at least perform: receiving an elevator site identifier from the user device; and determining a barometric pressure model to be applied based on the elevator site identifier.

In an implementation form of the first aspect, the at least one memory stores instructions that, when executed by the at least one processor, cause the system to at least perform: calibrating a barometric pressure sensor device by determining a reference barometric pressure value for barometric pressure sensor devices associated with the same elevator landing; and determining a calibration offset value associated with the barometric pressure sensor device by the difference between the reference barometric pressure value and a barometric pressure value measurement from the barometric pressure sensor device.

In an implementation form of the first aspect, the at least one memory stores instructions that, when executed by the at least one processor, cause the system to at least perform: transmitting the calibration offset value associated with the barometric pressure sensor device to the barometric pressure sensor device.

In an implementation form of the first aspect, the at least one memory stores instructions that, when executed by the at least one processor, cause the system to at least perform: storing the calibration offset value associated with the barometric pressure sensor device in the at least one memory.

According to a second aspect, there is provided a system for determining a calibration offset value associated with a user device. The system comprises at least one processor, and at least one memory storing instructions that, when executed by the at least one processor, cause the system to at least perform: maintaining, based on barometric pressure value measurements from at least one barometric pressure sensor device arranged in at least one elevator landing, a barometric pressure model associated with a building comprising a plurality of elevator landings, the barometric pressure model identifying an air pressure at each elevator landing of the plurality of elevator landings; receiving, from the user device, a barometric pressure value associated with the user device and an elevator landing indication; and determining a calibration offset value associated with the user device based on the barometric pressure value associated with the user device, the elevator landing indication and the barometric pressure model.

In an implementation form of the second aspect, the at least one memory stores instructions that, when executed by the at least one processor, cause the system to at least perform: transmitting the calibration offset value associated with the user device to the user device.

In an implementation form of the second aspect, the at least one memory stores instructions that, when executed by the at least one processor, cause the system to at least perform: storing the calibration offset value associated with the user device in the at least one memory together with an identifier associated with the user device.

According to a third aspect, there is provided a user device for determining a calibration offset value associated with the user device. The user device comprises at least one processor, and at least one memory storing instructions that, when executed by the at least one processor, cause the user device to at least perform: obtaining a barometric pressure value from a barometer; obtaining a current elevator landing indication; and transmitting the barometric pressure value and the current elevator landing indication for calculating a calibration offset value associated with the user device.

In an implementation form of the third aspect, the at least one memory stores instructions that, when executed by the at least one processor, cause the user device to at least perform: receiving the calibration offset value; and storing the calibration offset value in the at least one memory.

According to a fourth aspect, there is provided a user device for determining a current elevator landing associated with the user device. The user device comprises at least one processor, and at least one memory storing instructions that, when executed by the at least one processor, cause the user device to at least perform: obtaining an indication that an elevator call is to be placed; obtaining a barometric pressure value from a barometer associated with the user device; transmitting the barometric pressure value to a system; receiving a current elevator landing corresponding to the barometric pressure value from the system; and causing display of the current elevator landing as a current elevator landing of the elevator call to be placed.

In an implementation form of the fourth aspect, the at least one memory stores instructions that, when executed by the at least one processor, cause the user device to at least perform: obtaining a calibration offset value associated with the user device from the at least one memory; and transmitting the calibration offset value together with the barometric pressure value to the system.

In an implementation form of the fourth aspect, the at least one memory stores instructions that, when executed by the at least one processor, cause the user device to at least perform: transmitting an identifier associated with the user device together with the barometric pressure value to the system to enable the system to retrieve a calibration offset value associated with the identifier.

In an implementation form of the fourth aspect, the at least one memory stores instructions that, when executed by the at least one processor, cause the user device to at least perform: obtaining positioning data associated with the user device; and transmitting the positioning data together with the barometric pressure value to the system.

According to a fifth aspect, there is provided an elevator system comprising at least one barometric pressure sensor device arranged in at least one elevator landing, and a system according to the first aspect.

According to a sixth aspect, there is provided a method for determining a current elevator landing associated with a user device. The method comprises maintaining, based on barometric pressure value measurements from at least one barometric pressure sensor device arranged in at least one elevator landing, a barometric pressure model associated with a building comprising a plurality of elevator landings, the barometric pressure model identifying an air pressure at each elevator landing of the plurality of elevator landings; obtaining, a barometric pressure value associated with the user device from the user device; and determining a current elevator landing associated with the user device based at least in part on the barometric pressure value and the barometric pressure model.

In an implementation form of the sixth aspect, the barometric pressure value associated with the user device comprises a barometric pressure value corrected with a calibration offset value associated with the user device.

In an implementation form of the sixth aspect, the method further comprises obtaining a calibration offset value associated with the user device; correcting the barometric pressure value based on the calibration offset value to determine a corrected barometric pressure value; and determining the current elevator landing associated with the user device based at least in part on the corrected barometric pressure value and the barometric pressure model.

In an implementation form of the sixth aspect, the method further comprises obtaining the calibration offset value associated with the user device from the user device together with the measured barometric pressure value associated with the user device.

In an implementation form of the sixth aspect, the method further comprises storing the calibration offset value associated with the user device in the at least one memory together with an identifier associated with the user device; receiving, from the user device, the identifier associated with the user device; and obtaining the calibration offset value associated with the user device from the at least one memory based on the identifier received from the user device.

In an implementation form of the sixth aspect, the method further comprises receiving, from the at least one barometric pressure sensor device arranged in at least one elevator landing, at least one barometric pressure value measurement update; and updating the barometric pressure model based on the at least one barometric pressure value measurement update.

In an implementation form of the sixth aspect, the method further comprises transmitting the current elevator landing associated with the user to the user device.

In an implementation form of the sixth aspect, the method further comprises determining a confidence level associated with the current elevator landing associated with the user device, the confidence level representing the compatibility of the barometric pressure value associated with the user device to the barometric pressure model; and transmitting the confidence level to the user device.

In an implementation form of the sixth aspect, the method further comprises obtaining an identifier associated with the user device; and transmitting the current elevator landing associated with the user device and the identifier associated with the user device to an elevator controller or an elevator group controller.

In an implementation form of the sixth aspect, the method further comprises receiving positioning data associated with the user device; and determining a barometric pressure model to be applied based at least in part on the positioning data.

In an implementation form of the sixth aspect, the method further comprises receiving an elevator site identifier from the user device; and determining a barometric pressure model to be applied based at least in part on the elevator site identifier.

In an implementation form of the sixth aspect, the method further comprises calibrating a barometric pressure sensor device by determining a reference barometric pressure value for barometric pressure sensor devices associated with the same elevator landing; and determining a calibration offset value associated with the barometric pressure sensor device by the difference between the reference barometric pressure value and a barometric pressure value measurement from the barometric pressure sensor device.

In an implementation form of the sixth aspect, the method further comprises transmitting the calibration offset value associated with the barometric pressure sensor device to the barometric pressure sensor device.

In an implementation form of the sixth aspect, the method further comprises storing the calibration offset value associated with the barometric pressure sensor device in the at least one memory.

According to a seventh aspect, there is provided a method for determining a calibration offset value associated with a user device. The method comprises maintaining, based on barometric pressure value measurements from at least one barometric pressure sensor device arranged in at least one elevator landing, a barometric pressure model associated with a building comprising a plurality of elevator landings, the barometric pressure model identifying an air pressure at each elevator landing of the plurality of elevator landings; receiving, from the user device, a barometric pressure value associated with the user device and an elevator landing indication; and determining a calibration offset value associated with the user device based at least in part on the barometric pressure value associated with the user device, the elevator landing indication and the barometric pressure model.

In an implementation form of the seventh aspect, the method further comprises transmitting the calibration offset value associated with the user device to the user device.

In an implementation form of the seventh aspect, the method further comprises storing the calibration offset value associated with the user device in the at least one memory together with an identifier associated with the user device.

According to an eighth aspect, there is provided a method for determining a calibration offset value associated with a user device. The method comprises obtaining a barometric pressure value from a barometer; obtaining a current elevator landing indication; and transmitting the barometric pressure value and the current elevator landing indication for calculating a calibration offset value associated with the user device.

In an implementation form of the eighth aspect, the method further comprises receiving the calibration offset value; and storing the calibration offset value in the at least one memory.

According to a night aspect, there is provided a method for determining a current elevator landing associated with the user device. The method comprises obtaining an indication that an elevator call is to be placed; obtaining a barometric pressure value from a barometer associated with the user device; transmitting the barometric pressure value to a system; receiving a current elevator landing corresponding to the barometric pressure value from the system; and causing display of the current elevator landing as a current elevator landing of the elevator call to be placed.

In an implementation form of the ninth aspect, the method further comprises obtaining a calibration offset value associated with the user device from the at least one memory; and transmitting the calibration offset value together with the barometric pressure value to the system.

In an implementation form of the ninth aspect, the method further comprises transmitting an identifier associated with the user device together with the barometric pressure value to the system to enable the system to retrieve a calibration offset value associated with the identifier.

In an implementation form of the ninth aspect, the method further comprises obtaining positioning data associated with the user device; and transmitting the positioning data together with the barometric pressure value to the system.

According to a tenth aspect, there is provided a computer program comprising instructions which, when the program is executed by at least one processor, cause a system to perform the method of the fifth, sixth or seventh aspect.

According to an eleventh aspect, there is provided a computer-readable medium comprising a computer program comprising instructions which, when the program is executed by at least one processor, cause a system to perform the method of the fifth, sixth or seventh aspect.

According to a twelfth aspect, there is provided a system for determining a current elevator landing associated with a user device. The system comprises means for: maintaining, based on barometric pressure value measurements from at least one barometric pressure sensor device arranged in at least one elevator landing, a barometric pressure model associated with a building comprising a plurality of elevator landings, the barometric pressure model identifying an air pressure at each elevator landing of the plurality of elevator landings; obtaining, from the user device, a barometric pressure value associated with the user device; and determining a current elevator landing associated with the user device based at least in part on the barometric pressure value and the barometric pressure model.

According to a thirteenth aspect, there is provided a system for determining a calibration offset value associated with a user device. The system comprises means for: maintaining, based on barometric pressure value measurements from at least one barometric pressure sensor device arranged in at least one elevator landing, a barometric pressure model associated with a building comprising a plurality of elevator landings, the barometric pressure model identifying an air pressure at each elevator landing of the plurality of elevator landings; receiving, from the user device, a barometric pressure value associated with the user device and an elevator landing indication; and determining a calibration offset value associated with the user device based at least in part on the barometric pressure value associated with the user device, the elevator landing indication and the barometric pressure model.

According to a fourteenth aspect, there is provided a user device for determining a calibration offset value associated with the user device. The user device comprises means for: obtaining a barometric pressure value from a barometer; obtaining a current elevator landing indication; and transmitting the barometric pressure value and the current elevator landing indication for calculating a calibration offset value associated with the user device.

According to a fifteenth aspect, there is provided a user device for determining a current elevator landing associated with the user device. The user device comprises means for: obtaining an indication that an elevator call is to be placed; obtaining a barometric pressure value from a barometer associated with the user device; transmitting the barometric pressure value to a system; receiving a current elevator landing corresponding to the barometric pressure value from the system; and causing display of the current elevator landing as a current elevator landing of the elevator call to be placed.

### BRIEF DESCRIPTION OF THE DRAWINGS

The accompanying drawings, which are included to provide a further understanding of the invention and constitute a part of this specification, illustrate examples of the invention and together with the description help to explain the principles of the invention. In the drawings:

FIG. 1A illustrates a flow diagram of a method according to an example embodiment.

FIG. 1B illustrates a flow diagram of a method according to an example embodiment.

FIG. 1C illustrates a flow diagram of a method according to an example embodiment.

FIG. 1D illustrates a flow diagram of a method according to an example embodiment.

FIG. 1E illustrates a flow diagram of a method according to an example embodiment.

FIG. 2A illustrates a block diagram of a system according to an example embodiment.

FIG. 2B illustrates a block diagram of a user device according to an example embodiment.

FIG. 3 illustrates an elevator system according to an example embodiment.

### DETAILED DESCRIPTION

Various examples and embodiments discussed below illustrate a solution in which a current elevator landing, i.e. a source floor, of a user can be determined using a barometric pressure measurement provided by a user device. This enables a solution in which a user does not have to manually enter the current elevator landing in an elevator call application executed in the user device.

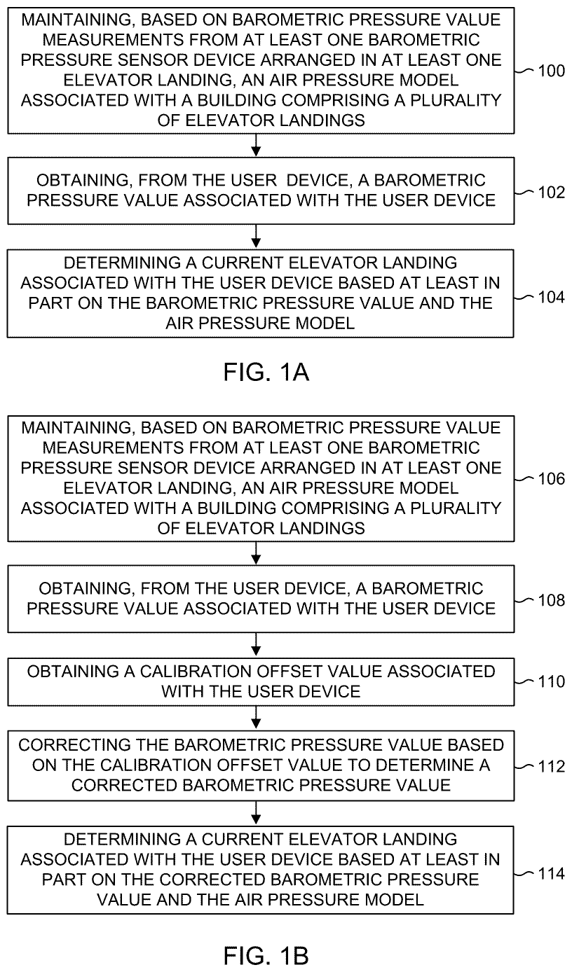

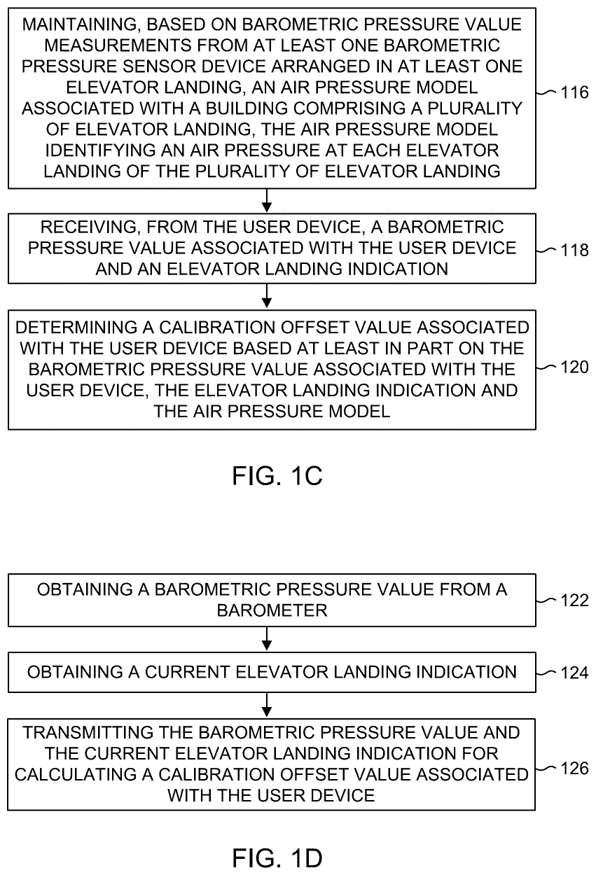

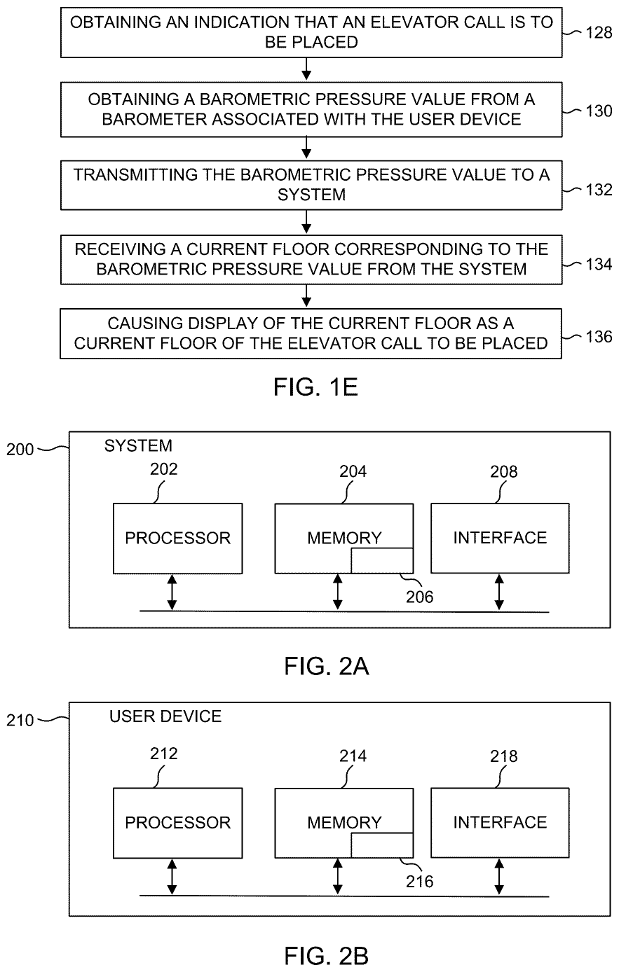

FIG. 1A illustrates a flow diagram according to an example for determining a current elevator landing associated with a user device. The method may be implemented, for example, by a system, for example, that is part of an elevator system, for example, an elevator controller or an elevator group controller, or by a system external to the elevator system and connected to the elevator system.

At 100, a barometric pressure model associated with a building comprising a plurality of elevator landings may be maintained based on barometric pressure value measurements from at least one barometric pressure sensor device arranged in at least one elevator landing. The barometric pressure model may identify air pressure at each elevator landing of the plurality of elevator landings. In an example embodiment, the barometric pressure model may be prepared based on barometric pressure measurement(s) from the at least one barometric pressure sensor device arranged in at least one elevator landing. If the barometric pressure is measured at each landing, the accuracy of the floor prediction is improved. However, in another example embodiment, the barometric pressure sensor devices need not be installed into all the elevator landings, as the pressure values can be both interpolated and extrapolated as needed.

In an example embodiment, the at least one barometric pressure sensor device may be calibrated. The calibration of the at least one barometric pressure sensor device can be achieved, for example, by determining a reference barometric pressure value for barometric pressure sensor devices associated with the same elevator landing. The determination of the reference barometric pressure value may be calculated, for example, averaging the measured values from all the devices in the same elevator landing adjusted by their relative installation height. For example, a barometric pressure sensor device arranged in a destination operating panel (DOP) may be installed about one meter from the floor while a lantern may usually be installed, for example, 2.3 meters from the floor. This means that the pressure measured by the lantern is expected to be slightly lower than the DOP. A calibration offset value associated with the barometric pressure sensor device may be determined by the difference between the reference barometric pressure value and a barometric pressure value measurement from the barometric pressure sensor device.

In another example embodiment, the pressure calibration of the at least one barometric pressure sensor can utilize the known floors and relative heights of the devices by fitting each device's reading and height from the ground floor to a physical model of ambient air pressure. The difference between each device's reading from the physical model can be used as the calibration offset value for each device. The calibration offset values for the signalization devices may be stored either in the system which runs the model of the ambient pressure in the landings or in the signalization devices themselves. Alternatively, the barometric pressure sensor devices may be calibrated in the factory during the production testing using some reference pressure or barometer reading. The calibration value for the device may be stored in non-volatile memory on the device or centrally by the system.

At 102, a barometric pressure value associated with the user device may be obtained from the user device. The barometric pressure value may have been measured using a barometer associated with the user device. At this point the user device is located at some landing, but it is not yet known which landing that is. In an example embodiment, the barometric pressure value may already take into account a calibration correction made by the user device. If a calibration offset value representing the amount of correction needed to a measured barometric pressure value is stored in the user device (or otherwise accessible to the user device), the user device may correct the measured barometric pressure value with the calibration offset value before sending to the system.

At 104, a current elevator landing associated with the user device may be determined based at least in part on the barometric pressure value and the barometric pressure model. As the barometric pressure model identifies an air pressure at each elevator landing of the plurality of elevator landings, the barometric pressure value received from the user device may, for example, be compared to the barometric pressure model, and select an elevator landing whose air pressure is the closest to the barometric pressure value received from the user device.

FIG. 1B illustrates a flow diagram according to an example for determining a current elevator landing associated with a user device. The method may be implemented, for example, by a system, for example, that is part of an elevator system, for example, an elevator controller or an elevator group controller, or by a system external to the elevator system.

At 106, a barometric pressure model associated with a building comprising a plurality of elevator landings may be maintained based on barometric pressure value measurements from at least one barometric pressure sensor device arranged in at least one elevator landing. The barometric pressure model may identify air pressure at each elevator landing of the plurality of elevator landings. In an example embodiment, the barometric pressure model may be prepared based on barometric pressure measurement from the at least one barometric pressure sensor device arranged in at least one elevator landing. If the barometric pressure is measured at each landing, the accuracy of the floor prediction is improved. However, in another example embodiment, the barometric pressure sensor devices need not be installed into all the elevator landings, as the pressure values can be both interpolated and extrapolated as needed.

In an example embodiment, the at least one barometric pressure sensor device may be calibrated. The calibration of the at least one barometric pressure sensor device can be achieved, for example, by determining a reference barometric pressure value for barometric pressure sensor devices associated with the same elevator landing. The determination of the reference barometric pressure value may be calculated, for example, averaging the measured values from all the devices in the same elevator landing adjusted by their relative installation height. For example, a barometric pressure sensor device arranged in a destination operating panel (DOP) may be installed about one meter from the floor while a lantern may usually be installed, for example, 2.3 meters from the floor. This means that the pressure measured by the lantern is expected to be slightly lower than the DOP. A calibration offset value associated with the barometric pressure sensor device may be determined by the difference between the reference barometric pressure value and a barometric pressure value measurement from the barometric pressure sensor device.

In another example embodiment, the pressure calibration of the at least one barometric pressure sensor can utilize the known floors and relative heights of the devices by fitting each device's reading and height from the ground floor to a physical model of ambient air pressure. The difference between each device's reading from the physical model can be used as the calibration offset value for each device. The calibration offset values for the signalization devices may be stored either in the system which runs the model of the ambient pressure in the landings or in the signalization devices themselves. Alternatively, the barometric pressure sensor devices may be calibrated in the factory during the production testing using some reference pressure or barometer reading. The calibration value for the device may be stored in non-volatile memory on the device or centrally by the system.

At 108, a barometric pressure value associated with the user device may be obtained from the user device. The barometric pressure value may have been read using a barometer associated with the user device. At this point the user device is located at some landing, but it is not yet known which landing this is.

At 110, a calibration offset value associated with the user device may be obtained. In an example embodiment, the calibration offset value may be known by the user device, and the user device transmits the calibration offset value together with the barometric pressure value at 108. In another example embodiment, the system may store the calibration offset value associated with the user device, for example, together with an identifier associated with the user device. When the user device sends the barometric pressure value to the system, the user device may explicitly send also its identifier to the system. The correct the calibration offset value may then be found by the system based on the identifier received from the user device.

At 112, the barometric pressure value received from the user may be corrected based on the calibration offset value to determine a corrected barometric pressure value, for example, by deducting/adding the calibration offset value from/to the barometric pressure value associated with the user device.

At 114, a current elevator landing associated with the user device may be determined based at least in part on the corrected barometric pressure value and the barometric pressure model. As the barometric pressure model identifies air pressure at each elevator landing of the plurality of elevator landings, the corrected barometric pressure value may, for example, be compared to the barometric pressure model, and a landing whose air pressure is the closest to the corrected barometric pressure value may be selected.

In an example embodiment of FIG. 1A and/or FIG. 1B, at least one barometric pressure value measurement update may be received from the at least one barometric pressure sensor device arranged in at least one elevator landing, and the barometric pressure model may be updated based on the at least one barometric pressure value measurement update. As the barometric pressure in the building may change over the time, the barometric pressure value measurement updates ensure that the barometric pressure model represents the currently prevailing barometric pressure levels in the building. In an example embodiment, the updates may be sent periodically, for example, once in 30 minutes or once in an hour. These are only some possible examples of an update frequency that can be used, and other update frequencies can be used. In another example embodiment, the barometric pressure value measurement updates may be sent non-periodically, for example, in response to a trigger condition. The trigger condition may be, for example, a change in the barometric pressure value measurement that exceeds a predetermined threshold value, for example, a predetermined difference from the previously measured barometric pressure value or a predetermined change in the barometric pressure within a time period. If the trigger condition is met, the barometric pressure value measurement update may be sent by the barometric pressure sensor device.

In an example embodiment of FIG. 1A and/or FIG. 1B, the current elevator landing associated with the user device may be transmitted to the user device. The barometric pressure value may be received from the user device when the user is about the make an elevator call with the user device. Before placing the elevator call, the current elevator landing, determined based on the barometric pressure value, to be used in the elevator call is transmitted to the user device from the system. Thus, when making the elevator call, the user does not have to manually input the current elevator landing.

In an example embodiment of FIG. 1A and/or FIG. 1B, a confidence level associated with the current elevator landing associated with the user device may be determined. The confidence level may represent the compatibility of the barometric pressure value associated with the user device to the barometric pressure model. The confidence level may then be transmitted to the user device. The confidence level thus represents how well the barometric pressure value provided by the user device fits into the barometric pressure model. It is possible that the elevator landing determined by the system is incorrect. In this case, the user can manually correct the floor using the elevator call application. In an example embodiment, the calibration offset value associated with the user device may be determined again.

In an example embodiment of FIG. 1A and/or FIG. 1B, positioning data associated with the user device may be received, and a barometric pressure model to be applied may be determined based on the positioning data. If positioning data associated with the user device is not obtained, the system may not necessarily know where the user device is located, i.e. in which building the user device is located. When the positioning data is available, the system is able to apply the correct barometric pressure model.

In an example embodiment of FIG. 1A and/or FIG. 1B, an elevator site identifier may be received from the user device, and a barometric pressure model to be applied may be determined based on the elevator site identifier. As the system may maintain simultaneously several barometric pressure models associated with different buildings and elevator systems, the barometric pressure model to be used with the user device may need to be identified. This may be enabled by the user device sending the elevator site identifier together with the barometric pressure value.

In an example embodiment of FIG. 1A and/or FIG. 1B, a barometric pressure sensor device may be calibrated by determining a reference barometric pressure value for barometric pressure sensor devices associated with the same elevator landing; and determining a calibration offset value associated with the barometric pressure sensor device by the difference between the reference barometric pressure value and a barometric pressure value measurement from the barometric pressure sensor device. While barometric pressure sensors may have high relative accuracy, i.e., they can detect the change in pressure when the sensor is moved, for example, 10 cm upwards or downwards, the absolute accuracy of the sensors may not be that accurate. It means that a direct comparison of barometer readings between different devices may lead to errors in the estimated vertical height between the devices. The measurement error of a barometer, however, is usually a constant offset which remains the same. This means that the error can be subtracted with a calibration offset value which corresponds to the specific barometer.

In an example embodiment of FIG. 1A and/or FIG. 1B, the calibration offset value associated with the barometric pressure sensor device may be transmitted to the barometric pressure sensor device. The calibration offset value associated with the barometric pressure sensor device may be stored in a memory of the barometric pressure sensor device. This enables a solution in which the barometric pressure sensor device may correct the barometric pressure value before sending it to the system. Alternatively, the barometric pressure sensor device may transmit the calibration offset value associated with the barometric pressure sensor device together with a measured barometric pressure value so that the system is able to make the barometric value correction.

In an example embodiment of FIG. 1A and/or FIG. 1B, the steps discussed relating to FIG. 1A and/or FIG. 1B may be performed by some other entity than an elevator controller or an elevator group controller. In this case, an identifier associated with the user device may be obtained from the user device, for example, together with the barometric pressure value, and the current elevator landing associated with the user device and the identifier associated with the user device may be transmitted to an elevator controller or an elevator group controller. In other words, in this example, the current elevator landing associated with the user device may not be transmitted back to the user device. Instead, the current elevator landing associated with the user device may be transmitted directly to the elevator controller or the elevator group controller. When the elevator controller or the elevator group controller then receives from the user device an elevator call including only the destination landing, it can be combined with the current elevator landing determined based on the barometric pressure value.

FIG. 1C illustrates a flow diagram according to an example for determining a calibration offset value associated with a user device. The method may be implemented, for example, by a system, for example, that is part of an elevator system, for example, an elevator controller or an elevator group controller, or by a system external to the elevator system.

At 116, a barometric pressure model associated with a building comprising a plurality of elevator landings may be maintained based on barometric pressure value measurements from at least one barometric pressure sensor device arranged in at least one elevator landing. The barometric pressure model may identify air pressure at each elevator landing of the plurality of elevator landings. In an example embodiment, the barometric pressure model may be prepared based on barometric pressure measurement from the at least one barometric pressure sensor device arranged in at least one elevator landing. If the barometric pressure is measured at each landing, the accuracy of the floor prediction may be improved. However, in another example embodiment, the barometric pressure sensor devices need not be installed into all the elevator landings, as the pressure values can be both interpolated and extrapolated as needed.

At 118, a barometric pressure value associated with the user device and an elevator landing indication may be received from the user device. The barometric pressure value and the indication may be received, when the user is explicitly performing a calibration procedure with an elevator call application executed in the user device. Alternatively, the barometric pressure value and the indication may be received, when the user is first setting up the elevator all application. When the user is in one of the elevator landings, the elevator call application may ask the user to select his/her current landing manually. The elevator call application then sends the barometer pressure reading to the system which uses the measured barometer pressure in that elevator landing to calculate the calibration offset value for the user device's barometer.

At 120, a calibration offset value associated with the user device may be determined based at least in part on the barometric pressure value associated with the user device, the elevator landing indication and the barometric pressure model. The calibration offset value represents how much a barometric pressure value measurement from the user device differs from a modelled value.

In an example embodiment, the calibration offset value associated with the user device may be transmitted to the user device. The user device may use the calibration offset value to calculate a corrected barometric pressure value or send the calibration offset value together with a measured barometric pressure value, when the user is later making an elevator call with an elevator call application executed by the user device.

In an example embodiment, the calibration offset value associated with the user device may be stored in a memory together with an identifier associated with the user device. If the system then later receives a measured barometric pressure value and the identifier from the user device, the system is able to retrieve the stored calibration offset value based on the identifier and user the calibration offset value to correct the measured barometric pressure value.

FIG. 1D illustrates a flow diagram according to an example for determining a calibration offset value associated with a user device. The method may be implemented, for example, by a user device, for example, a mobile device executing an elevator call application.

At 122, a barometric pressure value may be obtained from a barometer. The barometer may a built-in device in the user device.

At 124, a current elevator landing indication is obtained. In an example embodiment, the elevator call application may be configured to request the current elevator landing from the user.

At 126, the barometric pressure value and the current elevator landing indication is transmitted for calculating a calibration offset value associated with the user device. The barometric pressure value and the current elevator landing indication may be transmitted to a system configured to determine the calibration offset value. When the calibration offset value has been determined for the user device and when the user starts to make an elevator call with the elevator all application, the elevator call application may cause a barometric pressure value to be sent to the system and receive and estimated elevator landing floor, i.e., the source floor, for the elevator call from the system.

In an example embodiment, the calibration offset value may be received from the system and stored in a memory associated with the user device. The user device may then later use the calibration offset value to calculate a corrected barometric pressure value or send the calibration offset value together with a measured barometric pressure value, when the user is making an elevator call with an elevator call application.

FIG. 1E illustrates a flow diagram according to an example for determining a current elevator landing associated with the user device. The method may be implemented, for example, by a user device, for example, a mobile device executing an elevator call application.

At 128, an indication that an elevator call is to be placed may be obtained. The indication may be triggered, for example, when the user starts to make the elevator call with the elevator call application.

At 130, a barometric pressure value may be obtained from a barometer associated with the user device. In an example embodiment, the barometric pressure value may be obtained from the barometer after detecting the indication.

At 132, the barometric pressure value may be transmitted to a system.

At 134, a current elevator landing corresponding to the barometric pressure value may be received from the system. The system uses the barometric pressure value received from the user device to determine current elevator landing based on a barometric pressure model maintained by the system.

At 136, the current elevator landing may be caused to be displayed as a current elevator landing of the elevator call to be placed. In other words, the user does not have to manually input the current elevator landing in the elevator call application, when the user is about to make the elevator call. Instead, the current elevator landing is determined by the system based on the barometric pressure model maintained by the system.

In an example embodiment, the user device may have earlier received from the system a calibration offset value associated with the user device, and the calibration offset value may have been stored in a memory of the user device. When the user then later is about to make an elevator call, the calibration offset value may be retrieved from the memory, and the calibration offset value may be transmitted together with the barometric pressure value to the system. When the system knows the calibration offset value associated with the user device, the system is able to determine a corrected barometric pressure value associated with the user device.

In an example embodiment, an identifier associated with the user device may be transmitted together with the barometric pressure value to the system to enable the system to retrieve a calibration offset value associated with the identifier. The system may have earlier linked the identifier with the stored the calibration offset value associated with the user device. When the system receives the identifier from the user device, the system is able to retrieve a correct calibration offset value from its memory based on the identifier.

In an example embodiment, positioning data associated with the user device may be obtained, and the positioning data may be transmitted together with the barometric pressure value to the system. The positioning data may be, for example, satellite positioning data provided by the user device, or indoor positioning data provided by the user device. If positioning data associated with the user device is not available, the system may not necessarily know where the user device is located, i.e. in which building the user device is located. When the positioning data is available, the system is able to apply the correct barometric pressure model for the user device.

FIG. 2A illustrates a block diagram of a system 200 according to an example solution. The system 200 may comprise, for example, an elevator controller or elevator group controller functionality. In another example embodiment, the system 200 may be an external system connected to the elevator controller or elevator group controller, for example, a cloud-based system.

The system 200 comprises one or more processors 202, and one or more memories 204 that comprise computer program code 206, and/or a communication interface 208 for wired and/or wireless communication. Although the system 200 is depicted to include only one processor 202, the system 200 may include more than one processor. In an example embodiment, the memory 204 is capable of storing instructions, such as an operating system and/or various applications.

Furthermore, the processor 202 is capable of executing the stored instructions. In an example embodiment, the processor 202 may be embodied as a multi-core processor, a single core processor, or a combination of one or more multi-core processors and one or more single core processors. For example, the processor 202 may be embodied as one or more of various processing devices, such as a coprocessor, a microprocessor, a controller, a digital signal processor (DSP), a processing circuitry with or without an accompanying DSP, or various other processing devices including integrated circuits such as, for example, an application specific integrated circuit (ASIC), a field programmable gate array (FPGA), a microcontroller unit (MCU), a hardware accelerator, a special-purpose computer chip, or the like. In an example embodiment, the processor 202 may be configured to execute hard-coded functionality. In an example embodiment, the processor 202 may be embodied as an executor of software instructions, wherein the instructions may specifically configure the processor 202 to perform the algorithms and/or operations described herein when the instructions are executed, for example, the steps discussed relating to any of FIGS. 1A, 1B and 1C.

The memory 204 may be embodied as one or more volatile memory devices, one or more non-volatile memory devices, and/or a combination of one or more volatile memory devices and non-volatile memory devices. For example, the memory 204 may be embodied as semiconductor memories (such as mask ROM, PROM (programmable ROM), EPROM (erasable PROM), flash ROM, RAM (random access memory), etc.).

The at least one memory 204 may store program instructions that, when executed by the at least one processor 202, cause the system 200 to perform the functionality of the various embodiments discussed herein. Further, in an embodiment, at least one of the processor 202 and the memory 204 may constitute means for implementing the discussed functionality. For example, the system 200 may be configured to maintain, based on barometric pressure value measurements from at least one barometric pressure sensor device arranged in at least one elevator landing, a barometric pressure model associated with a building comprising a plurality of elevator landings, the barometric pressure model identifying air pressure at each elevator landing of the plurality of elevator landings; obtain, from the user device, a barometric pressure value associated with the user device; and determine a current elevator landing associated with the user device based at least in part on the barometric pressure value and the barometric pressure model. In another example, the system 200 may be configured to maintain, based on barometric pressure value measurements from at least one barometric pressure sensor device arranged in at least one elevator landing, a barometric pressure model associated with a building comprising a plurality of elevator landings, the barometric pressure model identifying air pressure at each elevator landing of the plurality of elevator landings; receive, from the user device, a barometric pressure value associated with the user device and an elevator landing indication; and determine a calibration offset value associated with the user device based at least in part on the barometric pressure value associated with the user device, the elevator landing indication and the barometric pressure model. A computer program may comprise instructions which, when the program is executed by the at least one processor 202, cause the system 200 to perform any of the methods described above. Furthermore, a computer-readable medium may comprise the computer program.

FIG. 2B illustrates a block diagram of a user device 210 according to an example solution. The user device 210 may comprise, for example, a mobile device, for example, a smart phone or a tablet computer.

The user device 210 comprises one or more processors 202, and one or more memories 214 that comprise computer program code 216, and/or a communication interface 208 for wired and/or wireless communication. Although the user device 210 is depicted to include only one processor 212, the user device 210 may include more than one processor. In an example embodiment, the memory 214 is capable of storing instructions, such as an operating system and/or various applications.

Furthermore, the processor 212 is capable of executing the stored instructions. In an example embodiment, the processor 212 may be embodied as a multi-core processor, a single core processor, or a combination of one or more multi-core processors and one or more single core processors. For example, the processor 212 may be embodied as one or more of various processing devices, such as a coprocessor, a microprocessor, a controller, a digital signal processor (DSP), a processing circuitry with or without an accompanying DSP, or various other processing devices including integrated circuits such as, for example, an application specific integrated circuit (ASIC), a field programmable gate array (FPGA), a microcontroller unit (MCU), a hardware accelerator, a special-purpose computer chip, or the like. In an example embodiment, the processor 212 may be configured to execute hard-coded functionality. In an example embodiment, the processor 212 may be embodied as an executor of software instructions, wherein the instructions may specifically configure the processor 212 to perform the algorithms and/or operations described herein when the instructions are executed, for example, the steps discussed relating to any of FIGS. 1D and 1E.

The memory 214 may be embodied as one or more volatile memory devices, one or more non-volatile memory devices, and/or a combination of one or more volatile memory devices and non-volatile memory devices. For example, the memory 204 may be embodied as semiconductor memories (such as mask ROM, PROM (programmable ROM), EPROM (erasable PROM), flash ROM, RAM (random access memory), etc.).

The at least one memory 214 may store program instructions that, when executed by the at least one processor 212, cause the user device 210 to perform the functionality of the various embodiments discussed herein. Further, in an embodiment, at least one of the processor 212 and the memory 214 may constitute means for implementing the discussed functionality. For example, the user device 210 may be configured to obtain a barometric pressure value from a barometer; obtain a current elevator landing indication; and transmit the barometric pressure value and the current elevator landing indication for calculating a calibration offset value associated with the user device. In another example, the user device 210 may be configured to obtain an indication that an elevator call is to be placed; obtain a barometric pressure value from a barometer associated with the user device; transmit the barometric pressure value to a system; receive a current elevator landing corresponding to the barometric pressure value from the system; and cause display of the current elevator landing as a current elevator landing of the elevator call to be placed. A computer program may comprise instructions which, when the program is executed by the at least one processor 212, cause the user device 210 to perform any of the methods described above. Furthermore, a computer-readable medium may comprise the computer program.

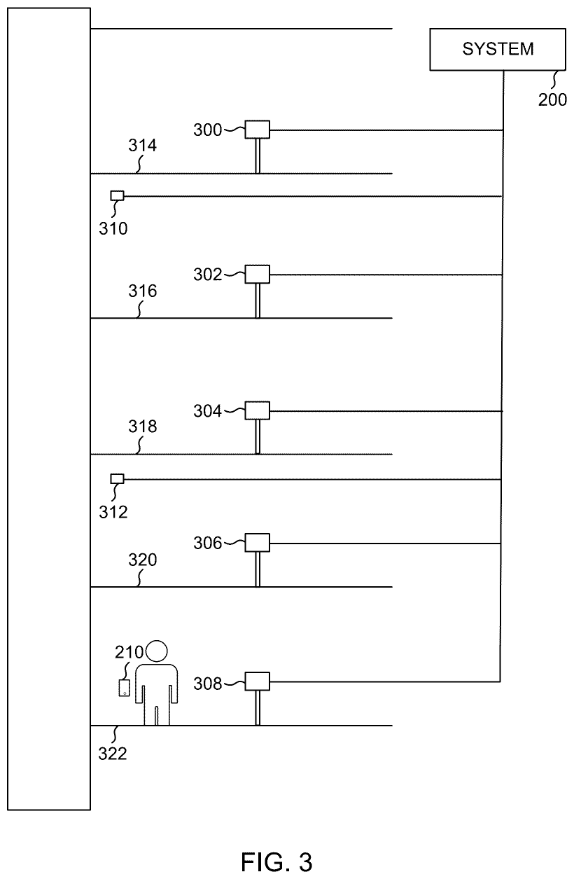

FIG. 3 illustrates an elevator system according to an example embodiment. The elevator system comprises the system 200 and at least one barometric pressure sensor device 300-312 arranged in at least one elevator landing 314-322. One or more barometric pressure sensor devices may be arranged, for example, in destination operating panels (DOP), as indicated by references 300-308. Additionally or alternatively, one or more barometric pressure sensor devices may be arranged, for example, as stand-alone device, as indicated by references 310, 312. The user device 210 may be executing an elevator call application to make an elevator call. The system 200 may be configured to implement the functionality discussed, for example, relating to FIGS. 1A-1C. The user device 210 may be configured to implement the functionality discussed, for example, relating to FIGS. 1D-1E.

One or more of the examples and example embodiments discussed above may enable a solution for determining a source floor of the elevator made using a user device so that the user does not have to manually input the source floor into the elevator call application executed in the user device.

The examples discussed above may be implemented in software, hardware, application logic or a combination of software, hardware and application logic. The example devices can store information relating to various methods described herein. This information can be stored in one or more memories, such as a hard disk, a solid state drive (SSD), an optical disk, a magneto-optical disk, an RAM, and the like. One or more databases can store the information used to implement the examples. The databases can be organized using data structures (e.g., records, tables, arrays, fields, graphs, trees, lists, and the like) included in one or more memories or storage devices listed herein. The methods described with respect to the examples can include appropriate data structures for storing data collected and/or generated by the methods of the devices and subsystems of the examples in one or more databases.

The components of the examples may include computer readable medium or memories for holding instructions programmed according to the teachings and for holding data structures, tables, records, and/or other data described herein. In an example, the application logic, software or an instruction set is maintained on any one of various conventional computer-readable media. In the context of this document, a “computer-readable medium” may be any media or means that can contain, store, communicate, propagate or transport the instructions for use by or in connection with an instruction execution system, apparatus, or device, such as a computer. A computer-readable medium may include a computer-readable storage medium that may be any media or means that can contain or store the instructions for use by or in connection with an instruction execution system, apparatus, or device, such as a computer. A computer readable medium can include any suitable medium that participates in providing instructions to a processor for execution. Such a medium can take many forms, including but not limited to, non-volatile media, volatile media, transmission media, and the like.

While there have been shown and described and pointed out fundamental novel features as applied to preferred examples thereof, it will be understood that various omissions and substitutions and changes in the form and details of the devices and methods described may be made by those skilled in the art without departing from the spirit of the disclosure. For example, it is expressly intended that all combinations of those elements and/or method steps which perform substantially the same function in substantially the same way to achieve the same results are within the scope of the disclosure. Moreover, it should be recognized that structures and/or elements and/or method steps shown and/or described in connection with any disclosed form or example may be incorporated in any other disclosed or described or suggested form as a general matter of design choice. Furthermore, in the claims means-plus-function clauses are intended to cover the structures described herein as performing the recited function and not only structural equivalents, but also equivalent structures.

The applicant hereby discloses in isolation each individual feature described herein and any combination of two or more such features, to the extent that such features or combinations are capable of being carried out based on the present specification as a whole, in the light of the common general knowledge of a person skilled in the art, irrespective of whether such features or combinations of features solve any problems disclosed herein, and without limitation to the scope of the claims. The applicant indicates that the disclosed aspects/embodiments may consist of any such individual feature or combination of features. In view of the foregoing description it will be evident to a person skilled in the art that various modifications may be made within the scope of the disclosure.

1-50. (canceled)

51. A method for determining a current elevator landing associated with a user device, the method comprising:
maintaining, based on barometric pressure value measurements from at least one barometric pressure sensor device arranged in at least one elevator landing, a barometric pressure model associated with a building comprising a plurality of elevator landings, the barometric pressure model identifying air pressure at each elevator landing of the plurality of elevator landings;
obtaining, a barometric pressure value associated with the user device from the user device, wherein the barometric pressure value associated with the user device comprises a barometric pressure value corrected with a calibration offset value associated with the user device; and
determining a current elevator landing associated with the user device based at least in part on the barometric pressure value and the barometric pressure model.

52. The method according to claim 51, further comprising:
obtaining a calibration offset value associated with the user device;
correcting the barometric pressure value based on the calibration offset value to determine a corrected barometric pressure value; and
determining the current elevator landing associated with the user device based at least in part on the corrected barometric pressure value and the barometric pressure model.

53. The method according to claim 52, further comprising:
obtaining the calibration offset value associated with the user device from the user device together with the measured barometric pressure value associated with the user device.

54. The method according to claim 52, further comprising:
storing the calibration offset value associated with the user device in the at least one memory together with an identifier associated with the user device;
receiving, from the user device, the identifier associated with the user device; and
obtaining the calibration offset value associated with the user device from the at least one memory based on the identifier received from the user device.

55. The method according to claim 51, further comprising:
receiving, from the at least one barometric pressure sensor device arranged in at least one elevator landing, at least one barometric pressure value measurement update; and
updating the barometric pressure model based on the at least one barometric pressure value measurement update.

56. The method according to claim 51, further comprising:
transmitting the current elevator landing associated with the user to the user device.

57. The method according to claim 56, further comprising:
determining a confidence level associated with the current elevator landing associated with the user device, the confidence level representing the compatibility of the barometric pressure value associated with the user device to the barometric pressure model; and
transmitting the confidence level to the user device.

58. The system according to claim 51, the at least one memory storing instructions that, when executed by the at least one processor, cause the system to at least perform:
obtaining an identifier associated with the user device; and
transmitting the current elevator landing associated with the user device and the identifier associated with the user device to an elevator controller or an elevator group controller.

59. The method according to claim 51, further comprising:
receiving positioning data associated with the user device; and
determining a barometric pressure model to be applied based on the positioning data.

60. The method according to claim 51, further comprising:
receiving an elevator site identifier from the user device; and
determining a barometric pressure model to be applied based on the elevator site identifier.

61. The method according to claim 51, further comprising:
calibrating a barometric pressure sensor device by
determining a reference barometric pressure value for barometric pressure sensor devices associated with the same elevator landing;
determining a calibration offset value associated with the barometric pressure sensor device by the difference between the reference barometric pressure value and a barometric pressure value measurement from the barometric pressure sensor device.

62. The method according to claim 61, further comprising:
transmitting the calibration offset value associated with the barometric pressure sensor device to the barometric pressure sensor device.

63. The method according to claim 61, further comprising:
storing the calibration offset value associated with the barometric pressure sensor device in the at least one memory.

64. A system for determining a current elevator landing associated with a user device, the system comprising:
at least one processor; and
at least one memory storing instructions that, when executed by the at least one processor, cause the system to at least perform the method of claim 51.

65. An elevator system comprising:
at least one barometric pressure sensor device arranged in at least one elevator landing; and
a system according to claim 64.

66. A computer program comprising instructions which, when the program is executed by at least one processor, cause the least one processor to perform the method of claim 51.

67. A non-transitory computer-readable medium comprising a computer program comprising instructions which, when the program is executed by at least one processor, cause the at least one processor to perform the method of claim 51.

68. The method according to claim 52, further comprising:
receiving, from the at least one barometric pressure sensor device arranged in at least one elevator landing, at least one barometric pressure value measurement update; and
updating the barometric pressure model based on the at least one barometric pressure value measurement update.

69. The method according to claim 53, further comprising:
receiving, from the at least one barometric pressure sensor device arranged in at least one elevator landing, at least one barometric pressure value measurement update; and
updating the barometric pressure model based on the at least one barometric pressure value measurement update.

70. The method according to claim 54, further comprising:
receiving, from the at least one barometric pressure sensor device arranged in at least one elevator landing, at least one barometric pressure value measurement update; and
updating the barometric pressure model based on the at least one barometric pressure value measurement update.
